(19) United States
(12) Patent Application Publication
(10) Pub. No.: US 2016/0277413 A1
(43) Pub. Date: Sep. 22, 2016

(54) Access Permission Device, Access Permission Method, Program, and Communicating System

(71) Applicant: Kabushiki Kaisha Toshiba, Tokyo (JP)

(72) Inventors: Daisuke AJITOMI, Tokyo (JP); Keisuke MINAMI, Kawasaki (JP); Hiroshi KAWAZOE, Kawasaki (JP); Hiroyuki AIZU, Yokohama (JP)

(73) Assignee: Kabushiki Kaisha Toshiba

(21) Appl. No.: 15/069,333

(22) Filed: Mar. 14, 2016

(30) Foreign Application Priority Data
Mar. 20, 2015 (JP) 2015-058684
Mar. 9, 2016 (JP) 2016-046197

(51) Int. Cl. H04L 29/06

(52) U.S. Cl. CPC H04L 63/102; H04L 63/0281

(57) ABSTRACT

According to one embodiment of the present invention, an access permission device includes a communicator, a state evaluator, an access proxy, and a determiner. The communicator communicates with a target device connected to a network, and a communication device that can use a resource provided by the target device. The state evaluator acquires the communication device information to determine a connection state with the network from at least one of the communication device and the target device, and evaluates the connection state based on the information. The access proxy transmits a use request for the resource provided by the target device to the target device. The determiner determines, based on the connection state, which of the communication device and the access proxy transmits the use request for the resource provided by the target device to the target device.

### CROSS-REFERENCE TO RELATED APPLICATIONS

This application is based upon and claims the benefit of priority from Japanese Patent Application No. 2015-058684, filed Mar. 20, 2015 and No. 2016-46197 filed, Mar. 9, 2016; the entire contents of which are incorporated herein by reference.

### FIELD

Embodiments of the present invention relate to an access permission device, an access permission method, a program, and a communicating system.

### BACKGROUND

A method is known in which access permission for a REST API (Representational State Transfer Application Programming Interface) (hereafter, referred to as a private API) that a device in a home network such as a home appliance provides to an application installed in a smartphone or the like is performed by a device other than the home appliance. The access permission is the determination of whether a specified application may have access to the private API.

Meanwhile, in a system in which a device is connected to an external server on the Internet, that enables monitoring or controlling the device via the external server, a method is known in which the external server publishes a REST API similar to the private API, and the device is controlled via the REST API. The API published by the external server will be hereafter referred to as a public API.

A case where the above two APIs (the private API and the public API) coexist has an advantage in that a user can switch between the both. For example, by switching to the private API during in-home use, it is possible to prevent a control log from being left on a server. In addition, there is the possibility that the switching may be obligatory by law. However, there is no method to seamlessly switch the both while performing access permission to only a valid application.

### BRIEF DESCRIPTION OF THE DRAWINGS

FIG. 1 is a configuration diagram of a communicating system according to a first embodiment;

FIG. 2 is a diagram showing an example of information stored in a token storage;

FIG. 3 is a diagram showing an example of information stored in a target device information storage;

FIG. 4 is a diagram showing an example of a communication sequence according to the first embodiment;

FIG. 5 is a diagram showing the example of the communication sequence subsequent to FIG. 4;

FIG. 6 is a diagram showing a flow chart of a token issuance process;

FIG. 7 is a diagram showing the other configuration example of the communicating system according to the first embodiment;

FIG. 8 is a diagram showing still another configuration example of the communicating system according to the first embodiment;

FIG. 9 is a diagram showing still another configuration example of the communicating system according to the first embodiment;

FIG. 10 is a configuration diagram of a communicating system according to a second embodiment;

FIGS. 11A and 11B are diagrams showing examples of confirmation screens;

FIG. 12 is a diagram showing a configuration example of a communicating system according to a third embodiment;

FIG. 13 is a diagram showing a configuration example of a target device information storage according to the third embodiment;

FIG. 14 is a diagram showing an example of an operation sequence according to the third embodiment;

FIG. 15 is a diagram showing an example of the operation sequence according to the third embodiment;

FIG. 16 is a diagram showing an example of the operation sequence according to the third embodiment; and

FIG. 17 is a diagram showing the other configuration example of a communicating system according to a fourth embodiment.

### DETAILED DESCRIPTION

Embodiments of the present invention will be described below with reference to the drawings.

### First Embodiment

The present embodiment is characterized by performing control to automatically switch APIs to be used from public APIs to private APIs when a user gets home from outside the home. Hereinafter, the present embodiment will be described in detail.

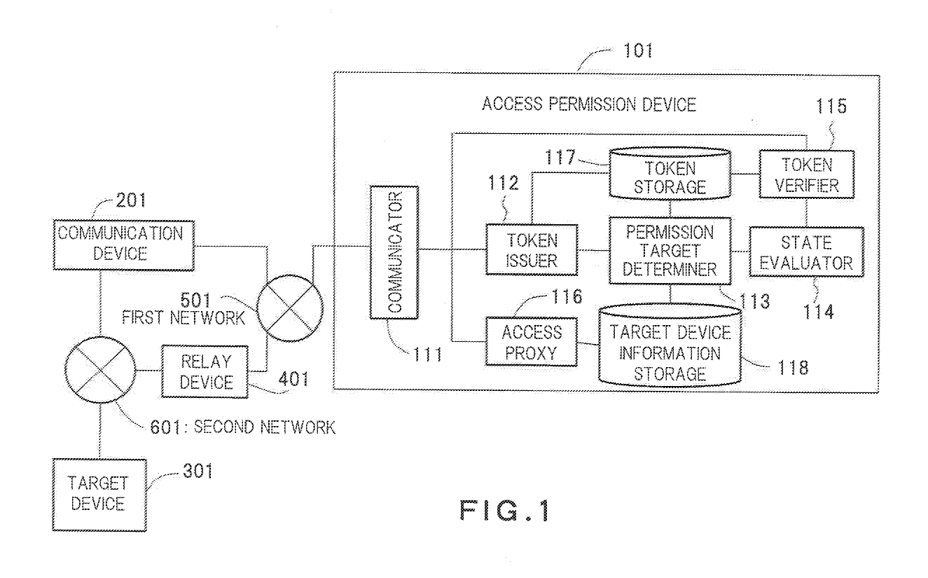

FIG. 1 is a configuration diagram of a communicating system according to a first embodiment of the present invention. The communicating system includes an access permission device 101, a communication device 201, a target device 301, a relay device 401, a first network 501, and a second network 601.

The first network 501 is a wide area network. In the present embodiment, more specifically, the wide area network is assumed to be the Internet. Note that, wide area network may be the other type of network including a closed network, such as NGN (Next Generation Network).

The second network 601 is a local communications network. In the present embodiment, more specifically, the local communications network is assumed to be a home network. It is no matter which of a wired medium (e.g., Ethernet®) and a wireless medium (e.g., WiFi, Bluetooth®, Zigbee®) is used as a physical medium. The higher-level communications protocol is assumed to be the IP (Internet Protocol), but any communications protocol may be used as long as the communication sequence of the present embodiment can be equally performed.

The relay device 401 is a router that connects the first network 501 and the second network 601. In the present embodiment, the relay device 401 is assumed to be a broadband router having a NAT (Network Address Translation) function of connecting the home network and the Internet.

The communication device 201 is a device used by an end user, such as a smartphone, tablet, PC, and the like. In the present embodiment, the communication device 201 is assumed to be a smartphone. A user carries about and uses the smartphone regardless of whether the user is out of home or at home. What the access permission device 101 authorizes is an application that has a program running on the smartphone as a component. In FIG. 1, the communication device 201 is shown as being connected to the first network 501 and the second network 601, but there are various connection states such as a state of being connected to the first network 501 but not to the second network 601, a state of being connected not the first network 501 but to the second network 601, and a state of being connected to both the networks.

The target device 301 is a device such as a home appliance and a sensor having a communicating function. In the present embodiment, the target device 301 is assumed to be a digital television that is connected to the home network under a broadband router. The target device 301 discloses REST APIs (Representational State Transfer Application Programming Interfaces) to the second network 601, namely, the home network. The REST APIs may be hereinafter referred to as private APIs. In the present embodiment, the target device 301 is assumed to disclose the private APIs as APIs that are accessible with HTTP (Hyper Text Transfer Protocol).

When connected to the target device 301 over the second network 601, the communication device 201 can use an Intended resource by transmitting an HTTP request to a private API of the target device 301 over the second network 601. As an example, an HTTP message is shown below that uses a private API to perform scheduled recording of a television program (hereinafter, referred to as a message A). Using an HTTP POST method, a channel, a date and time, and the like are specified in the HTTP request body. In this example, the intended resource is scheduled recording (reserved_programs) of the television (the target device 301). [Message A]

TABLE 1

POST/v1/reserved_programs HTTP/1.1
<HTTP header omitted>
channel=1&start_time=2014-11-30T00:00:00Z&end_time=2014
-11-30T00:00:00Z

As an example, an HTTP message is shown below that uses a private API to change the channel of the television (hereinafter, referred to as a message B). Using an HTTP PUT method, a channel is specified in the request body. In this example, the intended resource to be used by the communication device 201 is the status of the television (the target device 301).

### [Message B]

TABLE 2

POST/v1/status HTTP/1.1
<HTTP header omitted>
current_channel=1

The above messages are merely one form of implementing methods, and thus parameters and URLs are not limited to the above example.

The access permission device 101 is a server device that is connected to the first network 501.

The access permission device 101 is assumed to have the configuration of a typical computer that includes a CPU, memory, and storage, but may be fulfilled as a virtual server in a cloud system. In the present embodiment, more specifically, it is assumed that a software program implemented on the server device fulfills the functions of the access permission device 101 according to the present embodiment. The software program is assumed to have a permission server function that conforms to standard specifications, such as OAuth 2.0 and OpenID Connect 1.0, for fulfilling access permission on the Internet.

The access permission device 101 includes a communicator 111, a token issuer 112, a permission target determiner (a determiner) 113, a state evaluator 114, a token verifier 115, an access proxy 116, a token storage 117, and a target device information storage 118.

The communicator 111 communicates with the communication device 201 and the target device 301 over the first network 501. The communication with the target device 301 is performed via the relay device 401.

The access proxy 116 has public APIs and discloses the public APIs to the first network 501. As mentioned above, more specifically, the public APIs are provided as APIs accessible with HTTP in the present embodiment as with the private APIs.

For example, when the access permission device 101 has a domain “api.publiccontroller.example.com”, and the identifier of the target device 301 is defined as “xyz”, the URLs of public APIs corresponding to the private APIs of the target device 301 (see the above-mentioned messages A and B) can be expressed as follows, respectively.

TABLE 3
https://api.tvcontroller.example.com/v1/devices/xyz/reserved_programs
https://api.tvcontroller.example.com/v1/devices/xyz/status

The token issuer 112 receives, from the communication device 201, an access permission request for a resource of the target device 301 and performs the authentication of the communication device 201 as well as the authentication and permission of an access authorized user of the resource. When the authentication and the approval are successful, the token issuer 112 issues access permission information (an access token) to the communication device 201. There are an access token for accessing a private API and an access token for accessing a public API, and which access token to issue is determined depending on the result from the permission target determiner 113 and the state evaluator 114, which will be described later. Upon receiving the issuance of an access token for a public API or a private API, the communication device 201 becomes able to access a resource of the target device 301. In the case of a private API, the access to the resource is performed directly on the target device 301, and in the case of a public API, the access is performed by the access permission device 101 by proxy. Note that, this function is a basic function of a permission server in OAuth 2.0. The access permission request and the authentication, the permission, and the like based on the request are fulfilled through HTTPS communication following the standard specifications.

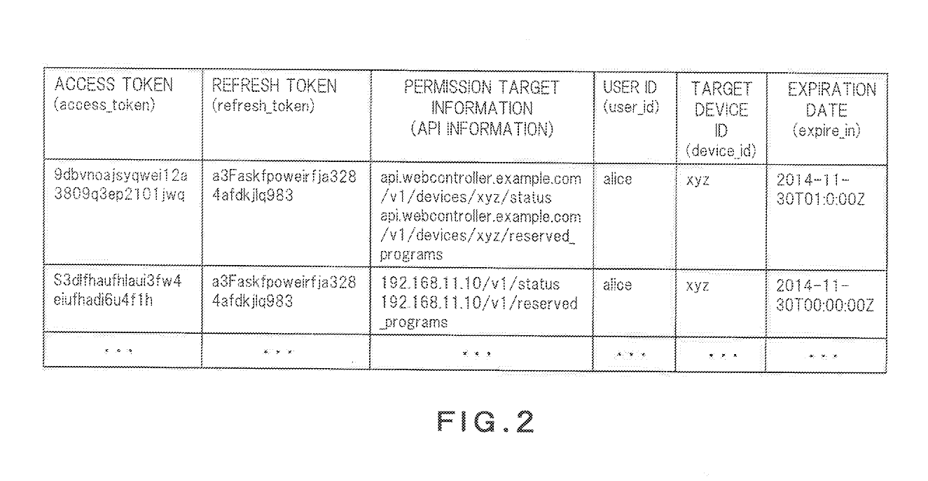

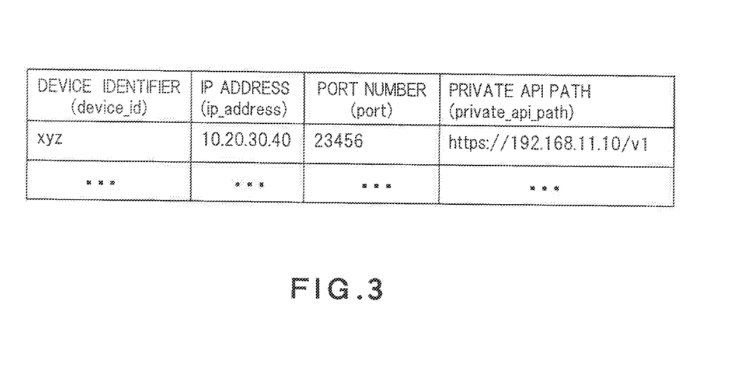

The token storage 117 store an access token issued by the token issuer 112, associating the access token with one or more pieces of API information that are used at the time of accessing a resource (see FIG. 2 to be described below). API information is an example of information relevant to an API. The other examples include an API path (part of a piece of API information) in FIG. 3, which will be described later.

API information allows the private API and the public API to be distinguished from each other by the description thereof. API information contains, for example, a URL to be used at the time of accessing a resource. In addition, in the token storage 117, the ID of a target device that becomes accessible and the UID of a user are stored, being associated with the access token. In addition, an expiration date is also set to the access token. A refresh token is issued simultaneously with the access token. The usage thereof will be described below.

Specific implementation forms of the token storage 117 itself may include a simple hash structure and a KVS (Key Value Store) in a volatile memory and include a relational database management system stored in a non-volatile storage. Any implementation methods may be employed as long as an access token can refer to relevant permission target information.

When receiving, from the communication device 201, a resource use request for a public API, the token verifier 115 verifies whether an access token contained in the access request is an issued and valid access token. In addition, when receiving a token issuance request from the communication device 201 and the token issuance request contains a refresh token, the token verifier 115 verifies whether the refresh token is an issued and valid one. The token verifier 115 receives an access token verification request from the target device 301 and verifies whether the access token contained in the verification request is an issued and valid refresh token. As with the token issuer 112, the verification request and the verification based on the request are fulfilled through HTTPS communication.

The target device information storage 118 holds information used to access the target device 301 (access information), a target device ID (a device identifier) to uniquely identify the target device 301, and the path to a private API. Access information includes an external IP address and port number of the target device 301. An external IP address is an IP address of the target device 301 that is recognized by the access permission device 101 at the time of communicating with the target device 301 and is normally identical to the global IP address that is allocated to a port on the first network 501 side of the relay device 401. Note that, as an IP address of the present embodiment, an IPv4 address or an IPv6 address may be used. Furthermore, an address of a kind other than the kind of IP address may be used.

There are various conceivable kinds of access information depending on communications systems between the access permission device 101 and the target device 301. For example, in schemes in which a communication connection from the target device 301 to the access permission device 101 is maintained (e.g., WebSocket, HTTP Long Polling), communication socket information may be added. Possible implementation forms of the storage itself include various forms as with the token storage 117.

In the present embodiment, a situation is assumed where the target device 301 uses the scheme (e.g., WebSocket, HTTP Long Polling) to maintain the communication connection with the access permission device 101. In the situation, the access permission device 101 can start a communication (e.g. a TCP communication) with the target device 301 via the relay device 401.

When a request (e.g., a token issuance request, a resource use request) from the communication device 201 is received, the state evaluator 114 evaluates the connection state of the communication device 201. More specifically, it is evaluated whether the communication device 201 is connected to the second network 601. In a specific deciding method, the state evaluator 114 refers to the external IP address of the target device 301 stored in the target device information storage 118 and evaluates whether the communication device 201 is connected to the second network 601 by judging whether the external IP address matches the source IP address of the request received by the access permission device 101. If the external IP address of the target device 301 matches the source IP address, it is evaluated that the communication device 201 is connected to second network 601, or if the external IP address of the target device 301 does not match the source IP address, it is evaluated that the communication device 201 is not connected to second network 601 (i.e., connected to the first network 501). The source IP address of the request is an example of information to identify the connection state of the communication device 201 to the second network 601 (whether the communication device 201 is connected to the second network 601 or whether the communication device 201 is in a connectable state).

Judging whether the communication device 201 is connected to the second network may be made by setting an IP address range for the target device and judging whether the source IP address falls within the relevant range (e.g., the IP address range that a plurality of target devices can take).

When the communication device 201 is connected to the second network 601, a user can be considered to be home, and thus it can be considered that the access is from home. When the communication device 201 is not connected to the second network 601, namely, connected to the first network 501, a user can be considered to be away from home, and thus it can be considered that the access is from out of home. Hereinafter, access to the access permission device 101 via the second network 601 may be expressed as from-home access, and access to the access permission device 101 not over the second network but over the first network 501 may be expressed as from-out-of-home access. The state evaluator 114 generates, based on an evaluation result, state information that represents the connection state of the communication device 201. State information represents whether access from the communication device 201 to the access permission device 101 is from-home access or from-out-of-home access.

Although it is determined here whether the communication device 201 is connected to the second network 601, it may be determined whether the communication device 201 is in a connectable state to the second network 601 while being connected to the first network 501. For example, if a user is in home, and the communication device 201 is connectable to the second network 601 at any time but actually connected to the first network 501, it can be determined that the communication device 201 is in a connectable state to the second network 601. To determine the connectable state, it may be determined whether the communication device 201 is present within a certain range from the target device 301. For example, it is assumed that the communication device 201 includes GPS incorporated, and placement position information on the target device 301 is previously acquired. In this case, the connectable state to second network 601 may be determined by acquiring position information in GPS from the communication device 201 and comparing the acquired position information with the placement position information. Alternatively, if the target device 301 includes GPS incorporated, the connectable state to the second network 601 may be determined by acquiring position information on the target device 301 in GPS and comparing the position information with the position information on the target device 301. If the communication device 201 is in the connectable state, a process in conformity with the connected state (in the case of from-home access) may be performed. In the case of accessing a private API, the communication device 201 may automatically switch the connection destination thereof from the first network 501 to the second network 601. Position information in GPS is an example of information to determine the connection state of the communication device 201 to the second network 601.

The permission target determiner 113 uses state information generated by the state evaluator 114 to determine which of a private API and a public API to be permitted as an access target. What is permitted by the permission target determiner 113 is an application installed in the communication device 201. As an example, if the state information represents from-home access, a private API is determined to be permitted, or if the state information represents from-out-of-home access, a public API is determined to be permitted. What is accessed by an application of the communication device 201 is the above private API or public API, and whether to authorize the access to the private API or the public API is determined. Determining a private API to be permitted means that the communication device 201 is to directly access a private API of the target device 301 (i.e., the communication device 201 is to transmit a resource use request to the target device 301). If a public API is determined to be permitted, the access proxy 116 receives the access to a public API from the communication device 201 and transmits a resource use request to the target device 301. A manner in which the access proxy 116 uses resources of the target device 301 may be previously defined. Dedicated APIs may be prepared, or data containing the URL of a private API may be transmitted to a target device, and the target device may interpret and execute the URL of a private API contained in the data.

Hereinafter, on the basis of a specific instance, the operation of this communicating system will be described. Before describing, there will be described an assumed scenario of user behavior and prerequisites of the communicating system.

### <Assumed Scenario>

A user operates, from out of home, a television remote control application (hereafter, referred to as a client) installed in a smartphone (the communication device 201) to perform scheduled program recording with a television (the target device 301) in the user's house. Subsequently, when returning home, the user turns on the power of the television using the television remote control application and switches a channel. At that point, a server (the access permission device 101) on the Web that provides a television remote control service performs control to automatically switch an API to be used such that a public API is used when the user is away from home or and a private API is used when the user is in home. Under the control, the communication device 201 accesses a public API when the user performs scheduled program recording, and accesses a private API when the user switches a channel. Such switching between APIs is automatically performed in response to the movement to home from the outside.

### <Prerequisites>

A remote control application (a client) on the smartphone (the communication device 201) holds, according to OAuth standard specifications, a client identifier (client_id) and client secret information (client_secret) that are issued by the server (the access permission device 101) providing the television remote control service. The issuance is made in such a manner that a developer of a client that accesses (acquires and changes) a specified resource applies to (an administrator of) the access permission device 101 for the registration of the client, and the administrator of the access permission device 101 approves the application. Typically, the registration, approval, and Issuance are automatically performed, but the present embodiment will not provide how to make the issuance. Note that, in the present embodiment, the specified resource is the status of the television (the target device 301), and scheduled recording (reserved_programs).

Also to the access permission device 101, the client_id and client_secret (not shown) are registered for client authentication.

In the target device information storage 118 of the access permission device 101, the external IP address of the target device 301 and the like are stored together with the Identification information on the target device 301 (device identifier: device_id) (see FIG. 3). The present embodiment will not provide how to register the information. The registration may be manually made to a database or may be automatically made by the target device 301 (the television) through communication with the access permission device 101.

A user of the communication device 201 is an owner of the target device 301, whose user account (user_id and user_password) is previously created in a server (the access permission device 101) that provides the television remote control service. Note that the user ID (user_id) is registered to the token storage 117, being associated with a token (see FIG. 2).

In the access permission device 101, the user and the target device 301 (the television) owned by the user are associated with each other. There are various conceivable implemented forms for how to associate them, but the present embodiment will not provide how to associate them. In the token storage 117, the association between the user and the target device 301 is registered by the association between the user ID (user_id) and the target device ID (device_id).

### <Communication Sequence in the Present Embodiment>

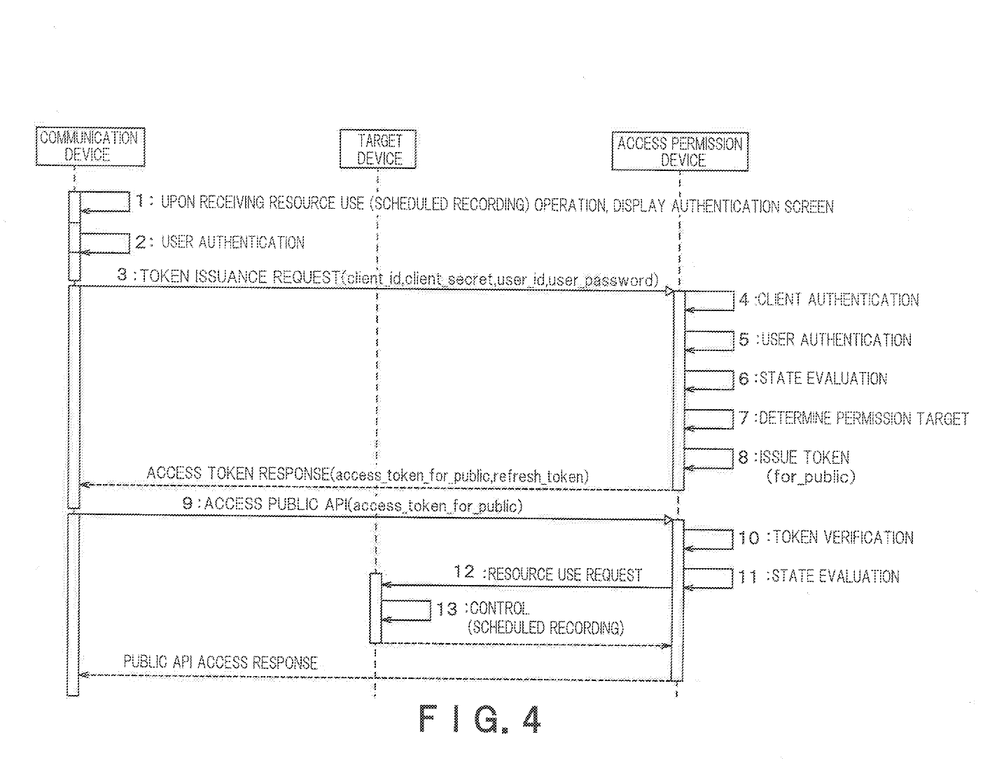

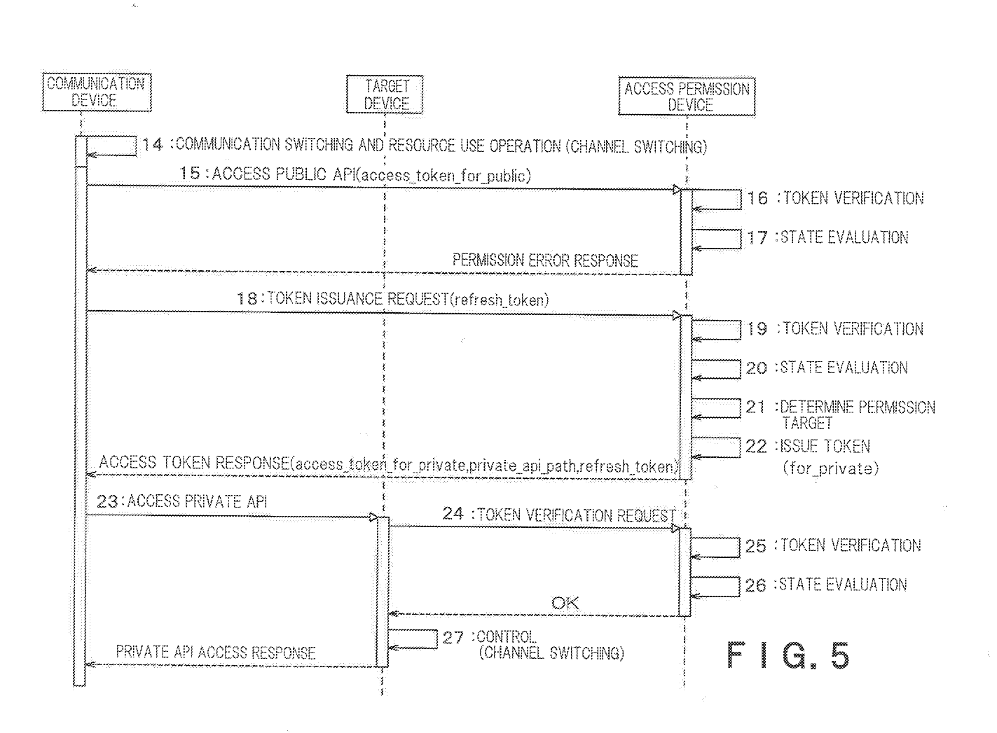

FIG. 4 shows a communication sequence performed among the target device 301, the communication device 201, and the access permission device 101 in the communicating system according to the present embodiment. FIG. 5 shows a communication sequence subsequent to that in FIG. 4. Reference numerals in FIG. 4 and FIG. 5 denote the numbers of steps.

(Step 1) A user starts the client on the communication device 201 and performs scheduled recording of an intended program (resource use). At that point, the client has not acquire an access token yet and thus displays to the user an authentication screen, on which the text explaining that the client requests resource use from the target device 301, an approval button, and a cancel button are shown. The authentication screen may be caused to show information to distinguish whether the user is in home or out of home (which of the first network 501 and the second network 601 is connected).
(Step 2) The user presses the approval button in the authentication screen. Although, in the present embodiment, the authentication screen is generated by the client, but a method in which an authentication request is transmitted to the access permission device 101, and the access permission device 101 transmits the authentication screen as a response may be employed. In this case, the authentication screen transmitted by the access permission device 101 as a response is shown on the communication device 201.
(Step 3) Upon receiving the approval of the user, the client transmits an access token issuance request (a permission request for the resource) to the token issuer 112 of the access permission device 101. At that point, the access token issuance request contains, as an implementation form, “client_id”, “client_secret”, “user_id”, “user_password”, and authenticated scope information (permission target information) that is information relevant to the requested API. The authenticated scope information contains, as an example, “192.168.11.19/v1/status”, and “192.168.11.19/v1/reserved_program”. If the access permission device recognizes “192.168.11.19/v1/”, the authenticated scope information may contain the “status” and the “reserved_program”.

The “user_id” and the “user_password” may be provided as input values from an input screen (or the user authentication screen in step 1 is possible) that is displayed to the user by the communication device 201 or may be previously stored in the communication device 201 and used.

The authenticated scope information may not be contained in the access token issuance request but stored in the access permission device 101 being associated previously with a client identifier (client_id). Note that the access token issuance request containing “client_id”, “client_secret”, “user_id”, and “user_password” conforms to an authentication method (grant type) called Resource Owner Password Credentials in OAuth 2.0. The present embodiment only describes a sequence conforming to the grant type, but the sequence may conform to the other grant types (Authorization Code, Implicit Grant, and Client Credentials Grant).

(Step 4) The token issuer 112 validates the client to be a proper client based on the “client_id” and the “client_secret” contained in the access token issuance request. A proper client is a client that is registered in and authenticated by the access permission device 101 previously.
(Step 5) The token issuer 112 validates the user to be a proper user based on the “user_id” and the “user_password”. A proper user is a user that is registered in and authenticated by the access permission device 101 previously. Since the user and the target device 301 are registered in the access permission device 101 being associated with each other, the target device 301 owned by the user is identified as a result of the authentication. The target device 301 owned by the user is here the television (device_id=xyz).
(Step 6) The state evaluator 114 acquires the source IP address of the access token issuance request and compares the source IP address with an IP address that corresponds to the television in the target device information storage 118 (see FIG. 3). The IP address corresponding to the television can be found by identifying the device (television) that is associated with the user in the token storage and identifying the IP address of the television from the target device information storage 118. If the source IP address and the corresponding IP address are different from each other, the access by the user is evaluated to be out-of-home access, or otherwise, the access is evaluated to be in-home access. Here, the access is evaluated to be out-of-home access.
(Step 7) The permission target determiner 113 determines public APIs (“api.tvcontroller.example.com/v1/devices/xyz/status” and “api.tvcontroller.example.com/v1/devices/xyz/reserved_program”) to be permission targets based on the evaluation result from the state evaluator 114 and the target device 301 (device_id=xyz) associated with the user. More specifically, in the information stored in the token storage 117 in FIG. 2, of the public API and the private API associated with a user (assumed to be “alice” in this example) and the target device 301 (xyz), a public API is determined from the evaluation result on whether the access is in-home access or not. In the information in FIG. 2, the discrimination between a public API and a private API may be made based on the description of the permission target information (API information) itself (e.g., the determination of being a private API is made if a private IP address is contained in the permission target information) or based on additional identification information that is provided to discriminate between a public API and a private API.
(Step 8) The token issuer 112 issues an access token for the public API based on the determination made by the permission target determiner 113 and transmits to the client an access token response that contains the issued access token. The issued access token is stored in the token storage 117 (the column of “access token” in the first row in FIG. 2). In the present embodiment, the token issuer 112 provides an expiration date to the issued access token (the column of “expiration date” In the first row in FIG. 2), and furthermore, also issues a refresh token used for updating the access token (the column of “refresh token” in the first row in FIG. 2). Also the refresh token is contained in the access token response to be transmitted to the client. Note that the access token response may contain public API information, or the public API information may be grasped by the client side previously.

The refresh token may provide an expiration date having a length greater than that of the access token. When the access token is expired, the state of the communication device 201 (in-home or out-of-home), which will be described below, is changed to cause token verification to fail, a client presents the refresh token to request the issuance of a new access token. Using a refresh token brings an advantage of not starting the process again with the user authentication. Note that, as will be described in the description of step 18 below, a form in which no refresh token is used is possible.

(Step 9) The client acquires the access token and refresh token for the public API contained in the access token response received from the access permission device 101. The client transmits a scheduled recording request (a resource use request) containing the access token to the public API (the access proxy 116). More specifically, the above-mentioned message A is transmitted to the URL of the public API “https://api.tvcontroller.example.com/v1/devices/xyz/reserved_programs”. Note that, in the example of the above-mentioned message A, the expression of the access token and the like are omitted.
(Step 10) The access proxy 116 receives the scheduled recording request containing the access token for the public API. At that point, the token verifier 115 checks that the access token contained in the scheduled recording request is valid and issued for the public API by referring to the token storage 117. That is, it is confirmed that the access token contained in the scheduled recording request is present in the token storage 117 and is not expired.
(Step 11) As in step 6, the state evaluator 114 compares the source IP address of the scheduled recording request with an IP address in the target device information storage 118, the IP address corresponding to the television (identified from “xyz” in the URL of the public API, for example) (see FIG. 3) to evaluate whether the scheduled recording request is of out-of-home access or in-home access. Here, the source IP address does not match the IP address corresponding to the television, and thus the scheduled recording request is determined to be of out-of-home access. The token verifier 115 evaluates the access token contained in the scheduled recording request to be valid and issued for the scheduled recording request made from out of home, based on the evaluation result from the state evaluator 114.
(Step 12) The access proxy 116 transmits the scheduled recording request being a resource use request to the target device 301. The transmitted scheduled recording request is received by the target device 301 via the first network 501, the relay device 401, and the second network 502.
(Step 13) The target device 301 receives the scheduled recording request from the access permission device 101 and performs scheduled recording based on the scheduled recording request. Upon performing the scheduled recording, the target device 301 transmits a completion report on the scheduled recording to the access permission device 101. The access permission device 101 receives the completion report on the scheduled recording from the target device 301. The access proxy 116 transmits a response that indicates that the requested scheduled recording has been completed (a public API access response) to the communication device 201.
(Step 14) The user gets home from outside the home and uses the client installed in the communication device 201 to switch a channel of the television. At that point, it is assumed that the communication is switched from mobile carrier communications used out of home (3G or LTE) to in-home WiFi. That is, it is assumed that the connection destination of the communication device 201 is switched from the first network 501 to the second network 601.
(Step 15) The client transmits a channel switch request containing the access token for the public API (resource use request) to a public API of the access proxy 116. More specifically, the above-mentioned message B is transmitted to the URL of the public API “https://api.tvcontroller.example.com/v1/devices/xyz/status”. Note that, in the example of the above-mentioned message B, the expression of the access token and the like are omitted.
(Step 16) The access proxy 116 receives the channel switch request containing the access token. At that point, as in step 10, the token verifier 115 checks that the access token is valid and Issued for the public API, by referring to the token storage 117.
(Step 17) As in step 11, the state evaluator 114 compares the source IP address of the channel switch request with an IP address in the target device information storage 118, the IP address corresponding to the television (identified from “xyz” in the URL of the public API) (see FIG. 3) to judge whether the channel switch request is of out-of-home access or in-home access. Here, the source IP address matches the IP address corresponding to the television, and thus the channel switch request is determined to be of in-home access. The token verifier 115 determines that the channel switch request results in permission error based on the evaluation result from the state evaluator 114. In response to the permission error, the access proxy 116 refuses access to the public API from home (the second network 601 under the relay device 401) and transmits a permission error response.
(Step 18) When receiving the permission error response, the client installed in the communication device 201 generates an access token issuance request and transmits the access token issuance request to the token issuer 112. The access token issuance request contains the refresh token that is issued in step 8. As a variation of the step, there is a method to transmit a new access token issuance request again without using a refresh token, as in step 3.
(Step 19) The token verifier 115 acquires the refresh token contained in the token issuance request and checks whether the acquired refresh token is registered in the token storage 117 (note that, at that point, the access token and the refresh token in the second row in FIG. 2 may not be registered). Since the acquired refresh token is registered in the token storage 117, the refresh token is evaluated to be a valid refresh token. At that point, the ID of the target device 301 being the issuance target of the refresh token, namely, “device_id” (=xyz) is acquired from the token storage 117.
(Step 20) As in step 17, the state evaluator 114 compares the source IP address of the token issuance request with an IP address in the target device information storage 118, the IP address corresponding to the television (xyz) (see FIG. 3) to judge whether the token issuance request is of out-of-home access or in-home access. Here, the source IP address matches the IP address corresponding to the television, and thus the token issuance request is evaluated to be of in-home access.
(Step 21) The permission target determiner 113 determines a private API (192.168.11.19/v1/status, reserved_program) installed in the target device 301 to be the access permission target of the communication device 201 based on the evaluation result from the state evaluator 114 and the target device 301 (device_id=xyz) associated with the user.
(Step 22) The token issuer 112 issues an access token for the private API based on the determination made by the permission target determiner 113. The issued access token is stored in the token storage 117 (the column of “access token” in the second row in FIG. 2). At that point, a refresh token having same value as that of the refresh token for the public API is stored in the token storage 117 as a refresh token for the access token for the private API (the column of “refresh token” in the second row in FIG. 2). In addition, the token issuer 112 acquires private API information (permission target information) in the token storage 117 in FIG. 2 and generates an access token response that contains the access token, the private API information, and the like. The token issuer transmits the access token response to the communication device 201. Note that the value of the refresh token for the private API may be different from that of the refresh token for the public API.
(Step 23) The client installed in the communication device 201 acquires the access token and the private API information contained in the access token response and transmits a channel switch request containing the acquired access token (resource use request) to the private API of the target device 301 (i.e. accesses the private API). Note that, if the communication device 201 recognizes the private API information previously, the access token response transmitted from the access permission device 101 may not contain the private API information. In this case, a configuration in which the access permission device 101 does not recognize the private API information may be employed.
(Step 24) The private API of the target device 301 receives the channel switch request containing the access token. The private API of the target device 301 acquires the access token contained in the channel switch request, generates a token verification request that contains the access token, and transmits the token verification request to the access permission device 101.
(Step 25) The communicator 111 of the access permission device 101 receives the token verification request transmitted from the target device 301. The token verifier 115 checks that the access token contained in the token verification request is valid and Issued for the private API of the target device 301, by referring to the token storage 117. Since the same value as that of the access token is stored for the target device 301, in the token storage 117, and the access token is not expired, it can be evaluated that the access token is valid. Note that the token verifier 115 may understand that the transmission source of the token verification request is the target device 301 (device_id=xyz), by causing the token verification request to contain “xyz” of the target device ID, and detecting “xyz” of the target device ID. Alternatively, if the case where the connection between the target device 301 and the access permission device 101 is maintained by Websocket, a scheme to always determine that the transmission source device of a request transmitted via the connection is the target device 301 (device_id=xyz). The determination may be made by a method other than those described here.
(Step 26) The state evaluator 114 compares the source IP address of the token verification request with an IP address in the target device information storage 118, the IP address corresponding to the television (xyz) (see FIG. 3) to judge whether the access by the communication device 201 (i.e., the access by the user) is out-of-home access or in-home access. Here, the source IP address matches the IP address corresponding to the television, and thus the access is evaluated to be in-home access. The source IP address contained in the token verification request is an example of information to identify the connection state of the communication device 201 with the second network 601. On the basis of the evaluation result (in-home access) from the state evaluator 114, the token verifier 115 evaluates that the access from the client to the target device 301 is valid access, (i.e., determines that the user intends to access the private API of the in-home target device 301 through the authentication and permission by the access permission device 101) and transmits to the target device 301 a response that indicates the verification result representing the evaluation.
(Step 27) The target device 301 determines that channel switching instructed in the private API access from the communication device 201 can be performed based on the verification result from the access permission device 101 and performs the channel switching. The target device 301 transmits a response that indicates the performing the channel switching (a private API access response) to the communication device 201.

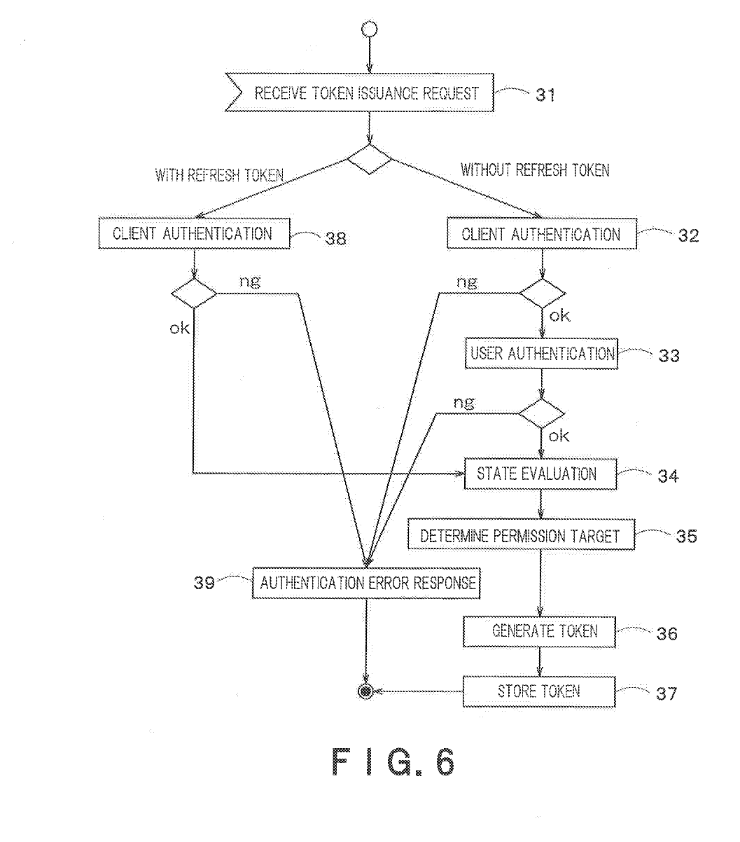

FIG. 6 is a flow chart of a process that is performed when the access permission device 101 receives the token issuance request from the communication device 201. In the sequence shown in FIG. 4 and FIG. 5 mentioned above, the token issuance request is received from the communication device 201 in step 3 and step 18.

When the token issuance request is received, it is determined whether the token issuance request contains a refresh token (step 31).

If no refresh token is contained, client authentication (step 32) and user authentication (step 33) is performed. The details of the client authentication and the user authentication are as mentioned above. If any one of the authentication fails, an authentication error response is transmitted to the communication device 201 and the process is finished (step 39). If both the authentication succeed, the state evaluation of the communication device 201 (evaluation of whether the user is in home or out of home) is made (step 34). The details of judging method are as mentioned above. Which of the public API and the private API is to be the access permission target is determined according to the result of the state evaluation (step 35), and an access token corresponding to the determined API is generated (step 36). The generated access token is stored in the token storage 117 being associated with the API information, the target device 301, the user, and the like (step 37).

In contrast, if the token issuance request contains a refresh token, the refresh token is verified (step 38). That is, it is determined whether the refresh token is registered in the token storage 117 in a valid manner. If the refresh token is registered in a valid manner, the state evaluation of the communication device 201 made in step 34 is made, and thereafter the above-mentioned steps 35 to 37 are performed. If the refresh token is not registered in the token storage 117 or if the refresh token is registered but expired, an authentication error response is transmitted to the communication device 201 and the process is finished (step 39).

Although the present embodiment describes the case where the number of target devices in home is one, but the present embodiment can be implemented also in the case of a plurality of target devices. At this point, access tokens for a public API and a private API may be issued for each target device, or the same access tokens may be shared among the plurality of target devices.

In addition, in the present embodiment, the relay device 401 is present separately from the communication device 201, but the communication device 201 may have a relaying function, and the target device 301 may use the relaying function of the communication device 201 to communicate with the access permission device 101. Also in this case, it can be considered that the communication device 201 and the target device 301 are connected to the same network.

In addition, in the present embodiment, the situation is assumed where the access permission device maintains the communication connection with the target device 301 all the time using Websocket or the like, but if the communication device 201 is evaluated to be connected to the second network 602 (or in a connectable state), the communication connection with the target device 301 may be disconnected. In addition, if the communication device 201 is not connected to the second network 602 (or in an unconnectable state), the communication connection with the target device 301 may be set again.

As described above, according to the present embodiment, in the issuance of an access token (steps 4 to 8 and 19 to 22), resource access using the access token (steps 9 to 12 and 15 to 17), and the verification of the access token (steps 25 and 26), the process is performed in accordance with the state of the communication device 201 (out of home or in home). More specifically, it is possible to force a client to use a public API when a user is out of home, or to always use a private API when the user is in home. At this point, the user does not need to be authorized again every time an API is switched, and an API to be used is switched without awareness of the user. The user uses a server (the access permission device 101) on the Internet (the first network 501) only when an API access is performed from out of home, it is possible to minimize a communication log that is left on the server, and to shorten a communication delay required for resource use by using direct communication over a home network (the second network 601) as much as possible.

Variations of the present embodiment will be described below.

### <Communication Sequence Variation (1)>

In steps 18 to 22 in FIG. 5, an access token is reissued, but a sequence without reissuing an access token is possible. Changes in the sequence of this case will be described below.

The authentication screen in step 1 in FIG. 4 is configured to cause the user to request authorization for an access token for both in-home and out-of-home accesses.

In the issuance of the token in step 8, an access token for both of a private API and a public API is issued. The issued access token is valid for both pieces of permission target information shown in the first and second row in FIG. 2.

No error response is transmitted in step 17, but a redirect response to a private API is transmitted to the communication device 201. The redirect response is made to contain private API information. The communication device 201 receiving the redirect response performs the operation of step 23 in FIG. 5 based on the private API information contained in the redirect response. This variation dispenses with the operations of steps 18 to 22.

### <Communication Sequence Variation (2)>

In the sequence shown in FIG. 4 and FIG. 5, the process is performed in the order of the token verification (the validity verification of a token) and the state evaluation (steps 10 and 11, steps 16 and 17, steps 19 and 20, and steps 25 and 26), but this part of the variation is implementation-dependent, and the state evaluation may be performed first.

### <Communication Sequence Variation (3)>

There will be described below a sequence in the case where, after step 27 in FIG. 5, the user get out of home from home and makes an additional scheduled recording, as steps 28 to 31.

(Step 28) The user gets out of home from home. At this point, the communication device 201 switches its communication from WiFi to mobile broadband communications such as 3G and LTE. That is, the communication device 201 switches the connection destination in communication from the second network 601 to the first network 501.
(Step 29) As in step 23, the client uses the access token for in-home access to transmit a scheduled recording request to the private API of the target device 301.
(Step 30) The access to the private API fails. That is, since the communication device 201 is connected to the first network 501 and the access is to the private API of the target device 301 in the second network 601, the communication fails (ends with timeout). For this reason, the client of the communication device 201 transmits a token issuance request to the token issuer 112 of the access permission device 101 over the first network 501. The token issuance request is made to contain a refresh token for the private API.
(Step 31) Thereafter, in an opposite manner to the case of getting home from outside the home, process of switching from an access token for in-home access to an access token for out-of-home access. Basically, the details of the process may be the same as those of the process of steps 19 to 22 and performed one by one. The access token for the public API that is issued in previous time is discarded, and an access token for the public API is newly reissued. However, the access token for the public API in previous time can be continuously used as it is. At this point, the expiration date thereof may be extended or may not be changed.

### <Communication Sequence Variation (4)>

As with Communication Sequence Variation (3), there will be described below a sequence in the case where, after step 27 in FIG. 5, the user gets out of home from home and makes an additional scheduled recording, as steps 32 to 37.

(Step 32) The user gets out of home from home. At this point, the communication device 201 switches its communication from WiFi to mobile wide are communications such as 3G and LTE. That is, the communication device 201 switches the connection destination in communication from the second network 601 to the first network 501.
(Step 33) As in step 18, the client uses the refresh token to transmit an issuance request for an access token to the token issuer 112. As described as step 3, the issuance request may be an issuance request for a new access token. In any way, while Variation (3) makes a token issuance request in response to access failure, this variation makes an access token issuance request every time (e.g., every time the client starts, every time the IP address of the client is changed, and every time a resource use request is made) not in response to access failure to the private API.
(Step 34) As in step 19, the token verifier 115 acquires the refresh token contained in the token issuance request and checks whether the acquired refresh token is registered in the token storage 117. Through this step, corresponding “device_id” (=xyz) is acquired.
(Step 35) As in step 6, the state evaluator 114 evaluates whether the token issuance request is of out-of-home access or in-home access. It is evaluated here that the access is of out-of-home access.
(Step 36) As in step 7, the permission target determiner 113 determines a public API installed in the target device 301 as the access permission target of the communication device 201 based on the evaluation result from the state evaluator 114 and the target device 301 (device_id=xyz) associated with the user.
(Step 37) As in step 22, the token issuer 112 issues an access token for the public API based on the determination of the permission target determiner 113. The issued access token is stored in the token storage 117. In addition, the token issuer 112 acquires public API information (permission target information) in the token storage 117 in FIG. 2 and generates an access token response that contains the access token, the public API information, and the like. The token issuer 112 transmits the access token response to the communication device 201. Note that the value of the refresh token for the public API may be different from that of the refresh token for the private API.

### <Communication Sequence Variation (5)>

As in Variations (3) and (4), there will be described a sequence variation in the case where, after step 27 in FIG. 5, the user gets out of home from home and makes an additional scheduled recording. Variation (3) describes the example in which the client tries accessing a private API, but in this variation, the client has a function of searching for a device having the private API and carries out the function every time (e.g., every time the client starts, every time the IP address of the client is changed, and every time a resource use request is made). More specifically, using a function of searching for peripheral equipment, such as multicast DNS, UPnP, and ECHONET Lite, a device having the private API is searched for (protocols are not limited to these three, there are a lot of examples in which the equivalent functions are defined in protocols directing home networks and the like, and such functions may be used). In regard to apparatus information on a device to be discovered (identification information on a device having the private API (e.g., IP address) or a private API), there are conceivable cases where when the access permission device issues an access token, the apparatus information is contained as related information in the access token (private_api_path in FIG. 5), where the access permission device has an API that provides the apparatus information in a separate manner, where the apparatus information is preset to the client previously, and the user manually sets the apparatus information to the client. If no target device is found the client transmits a token issuance request to the token issuer 112 of the access permission device 101, as in Variation (3).

### <Configuration Variation (1)>

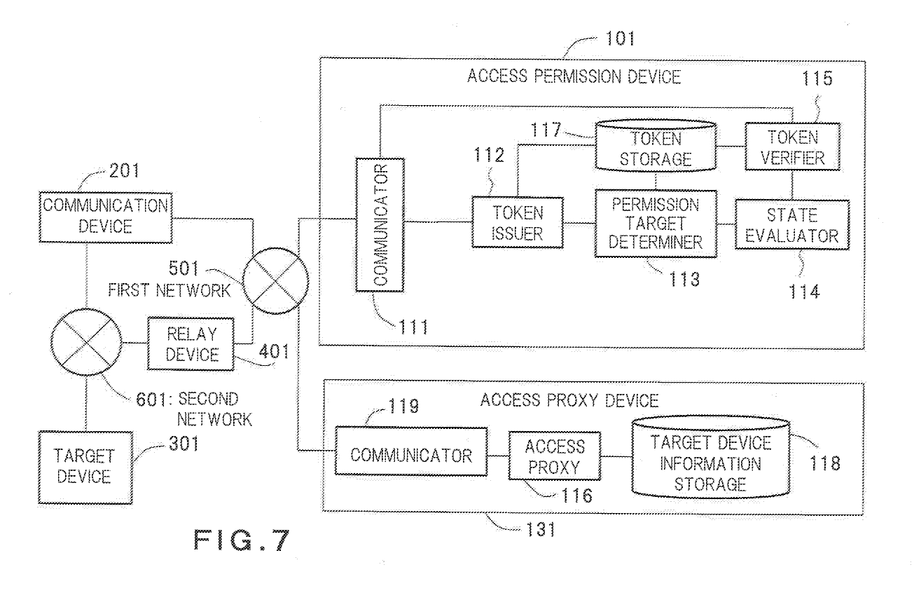

FIG. 7 shows the other configuration example of the communicating system according to the present embodiment. The access proxy 116 and the target device information storage 118 in FIG. 1 are removed from the access permission device 101 and disposed separately as an access proxy device (control proxy device) 131. The access proxy device 131 is connected to the first network 501 and includes an access permission device 121, the communication device 201, and a communicator 119 that communicates the target device 301.

As the other configuration example, a configuration is also common in which, all the storages such as the token storage 117 and the target device information storage 118 are separated as individual devices. In addition, components constituting the access permission device may be disposed as different devices in various combinations, and the cooperation among the functions of the components may be implemented through communication among the devices.

### <Configuration Variation (2)>

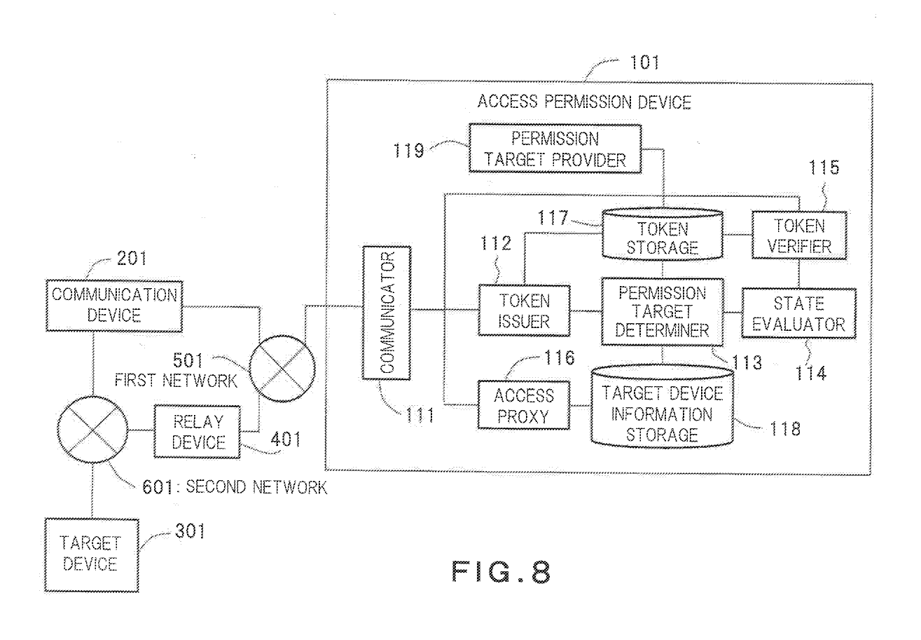

FIG. 8 shows still another configuration example of the communicating system according to the present embodiment. There is no change in the system configuration as a whole, but a permission target provider 119 is added. FIG. 5 shows the example in which the response to the token issuance request contains private API information (private_api_path), but this variation provides a configuration in which the function of providing the private API information is separated from the token issuer 112. In the configuration, the client separately accesses the permission target provider 119 in the access permission device after issuing an access token. The permission target provider 119 verifies the access token and thereafter transmits permission target information in the token storage 117 (API information) as a response.

### <Configuration Variation (3)>

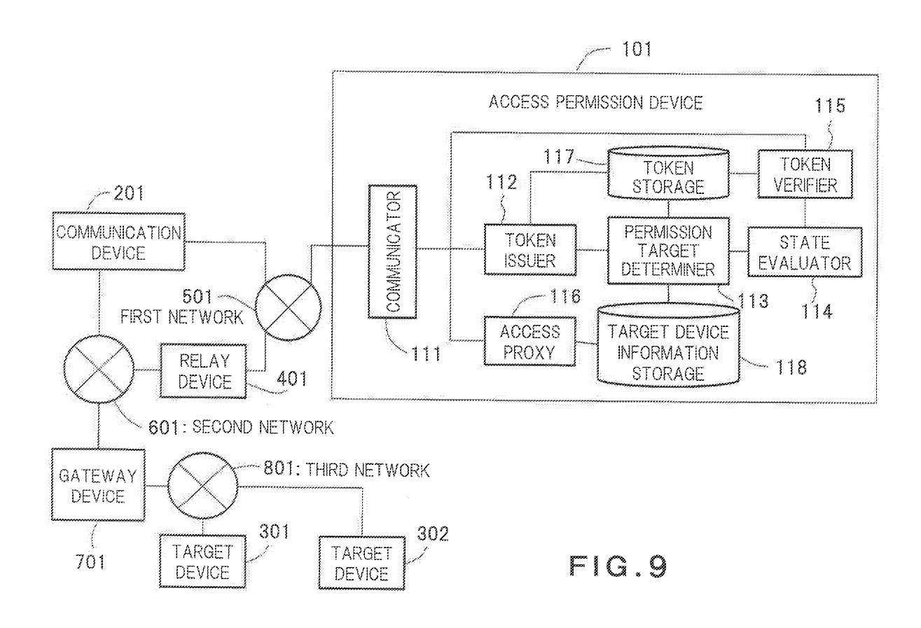

FIG. 9 shows still another configuration example of the communicating system according to the present embodiment. The difference from FIG. 1 is in that the communication device 201 is connected to one or more target devices via the gateway device 701. The gateway device and one or more target devices are connected over a third network 801 (being capable of communication). Each component will be described below.

The third network 801 may be, for example, a local network such as Bluetooth, wireless LAN, and Zigbee, or may be a wired line such as HDMI® and USB that connects the gateway device 701 and the target devices directly or via a hub. In addition, the third network 801 and the second network 601 may be the same network.

The target devices 301 and 302 in this variation may have a private API as described in the above embodiment but may have no private API. In the present embodiment, it is assumed the target devices 301 and 302 have no private API but have a communicating function of accepting resource use from the gateway device 701. More specifically, the target devices 301 and 302 are assumed to be devices, such as ECHONET Lite-supported home appliances, that conform a protocol to control the devices in some home network.

The gateway device 701 includes an interface to be connected to the second network 601 and an interface to be connected to the third network 801. The gateway device 701 is a device interposed between the communication device 201 and the target devices 301 and 302, and that relays a resource use request and resource use response. For example, the gateway device 701 may be a router device such as a broadband router, a device such as a PC and smartphone having a typical computer configuration, or a smart meter. That is, the gateway device 701 may be the same as the relay device 401, and furthermore, the same as the communication device 201. Here, the gateway device 701 is assumed to be a broadband router. The gateway device 701 has a private API and controls the target devices 301 and 302 connected thereto over the third network 801. That is, the gateway device 701 includes an access proxy similar to the access proxy 116 of the access permission device 101 and a registration unit that registers connected target device in the access permission device 101. In addition, the gateway device 701 has a function equivalent to the target device information storage 118, namely, conversion information to identify the target device of the resource use based on a request from the communication device 201 received by the access proxy of the gateway device 701. In the case where a device identifier is contained in a URL of an API, the gateway device 701 has a function of, for example, converting from the URL to a command to a control target device (e.g., ECHONET Lite request).

In this variation, APIs have a data structure assuming that the gateway device 701 newly includes a private API. An implementation form having the following configuration of public APIs is conceivable, which is however merely an example.

TABLE 4
https://api.tvcontroller.example.com/v1/gateways/abc/devices/xyz/
reserved_programs
https://api.tvcontroller.example.com/v1/gateways/abcdevices/xyz/status

In this case, in contrast, private APIs are defined as follows, for example.

TABLE 5

https://192.168.11.1/v1/devices/xyz/reserved_programs
https://192.168.11.1/v1/devices/xyz/status

To support this data structure, the table structure in the target device information storage 118 may be two-tier. That is, a conceivable method is to configure the table structure to contain a table in which a gateway identifier and base URLs (URLs for private and public) are stored, and a table consisting of target device information that contains an gateway identifier to which the target device belongs (in this case, the device identification information may not be uniquely identified in the access permission device, but may be an identifier having a level to the extent to which the identifier is uniquely identified in the gateway device).

Alternatively, the table structure may be configured to be one-tier, where each piece of target device information holds gateway identification information to which the target device belongs and the base URL information thereof (the permission target information in FIG. 2).

This configuration enables the access permission device 101 to specify the private API of an appropriate gateway device at the same time of specifying a target device. This variation enables seamless switching between a cloud API and the private API of a gateway device.

### Second Embodiment

The present embodiment is characterized by adding some functions such as asking a user whether to switch from using a public API to using a private API based on a policy setting on the user when the user gets home from outside the home. The present embodiment will be described below in detail.

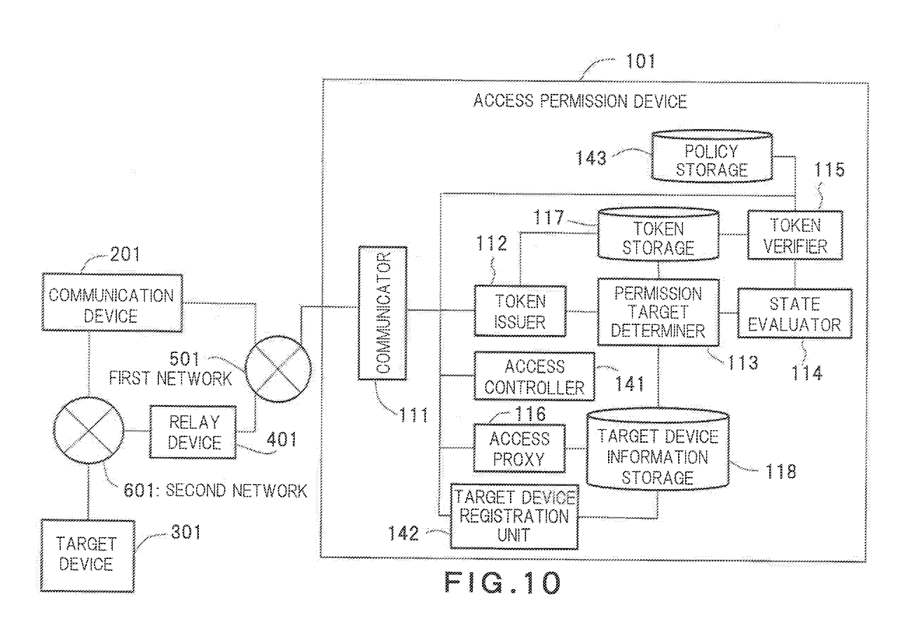

FIG. 10 shows a communicating system according to a second embodiment. The second embodiment differs from the first embodiment in the configuration of an access permission device. An access permission device 121 in the present embodiment includes a policy storage 143, a target device registration unit 142, and an access controller 141, which are newly added.

In the policy storage 143, policy information on API switching (or token switching) is stored. Policy information contains, as an example, a setting as to whether to ask the user the API switching (or token switching). Like the other example, a policy containing a setting showing that a public API is always used even when the user is in home is possible.

The target device registration unit 142 receives a registration request or an update request from the target device 301 and stores information in the target device information storage 118 or updates the information, in accordance with the request. In the present embodiment, the target device 301 issues an update request when the IP address or host name of the target device 301, both of them, and the like are changed. In the target device information storage 118, a private API path based on the IP address or host name is registered (see FIG. 3), and if the IP address or the host name is changed, the private API path is also changed. A scheme to generate a private API path from an IP address or a host name is assumed to be determined previously.

Alternatively, the target device 301 may generate the private API path based on the changed IP address or host name and transmit an update request that contains the private API path to the access permission device 151. In this case, the private API path contained in the update request may be registered in the target device information storage 118.

The same is true for a registration request, the target device registration unit 142 may generate a private API path based on an IP address or host name, or the target device 301 may generate the private API path based on the IP address or host name and transmit a registration request that contains the private API path to the access permission device 151. Note that it is assumed that when the private API path is changed or registered, the permission target information (API information) for the private API in the token storage 117 in FIG. 2 may be accordingly updated to one based on the changed private API path.

The target device registration unit 142 may be provided in the access permission device in FIG. 1, FIG. 7, FIG. 8, or FIG. 9.

The access controller 141 transmits an activating request for the private API to the target device 301 being an access target when the token issuer 112 issues an access token for the private API. Alternatively, the access controller 141 transmits a deactivating request for the private API to the target device 301 when the access token for private API is deactivated.

When receiving the activating request from the access controller 141, the target device 301 makes the private API of the target device 301 accessible from the home network (the second network 601). In addition, when receiving the deactivating request from the access controller 141, the target device 301 makes the private API of the target device 301 inaccessible from the home network (the second network 601). More specifically, the target device 301 starts or stops a server function of accepting access from the client installed in the communication device 201.

Alternatively, the access controller 141 may be configured to simply providing a trigger of the activation or deactivation, and whether to perform the activation or deactivation may be determined by the target device 301. In addition, the access controller 141 may be configured to transmit updated firmware that activates the private API at the first time of private API issuance to the target device.

A communication sequence according to the second embodiment will be described below. The description will be made here only on the difference from the communication sequence in the first embodiment (FIG. 4 and FIG. 5).

Prior to step 1 in FIG. 4, as an initial registration process, the target device 301 registers target device information such as an IP address in the target device information storage 118 via the target device registration unit 142 of the access permission device 151. At this point, the access permission device 151 needs to authenticate the target device 301. In addition, it is necessary to associate the user and the target device 301. There are various implementation methods for both the authentication and the association.

For example, secret information for device authentication is registered in the target device 301 previously, and the secret information is transmitted to the access permission device 151. This allows only a proper target device 301 to register its target device information in the access permission device 151. In addition, the user registers the information of the self-device in the access permission device 151 together with the secret information on the target device 301. As a simple implementing method, secret information is attached to the housing of the target device 301, and the secret information is manually registered by the user via a registration screen on the access permission device 151. The example described here is merely an example, and the other various methods are possible.

Note that, not only in the initial registration process, the target device 301 transmits an update request for the target device information in the access permission device 151 above every time the target device 301 detects the change of the apparatus information such as the change of the IP address. The target device registration unit 142 of the access permission device 151 updates information in the target device information storage 118 relevant to the target device 301 based on the update request.

On the authentication screen in step 1 FIG. 4, a selection interface for policy information is displayed, and when the user gets home from outside the home, policy information containing the setting as to whether to display a confirmation screen for API switching (token switching) may be displayed to the user in a selectable manner. The other kind of policy information may be displayed to allow the user to select any piece of policy information. Of course, the user may not select any piece of policy information, and the operation in this case is similar to that in the first embodiment.

In step 2 in FIG. 4, the user selects one of the pieces of policy information displayed on the authentication screen.

In step 3 in FIG. 4, a token issuance request to be transmitted from the communication device to the access permission device 151 is caused to contain the piece of policy information selected by the user.

In step 8 in FIG. 4, the policy information is registered being associated with an access token for the public API in the token issuance. In the above example, the setting of the policy information is linked to the authentication of the user performed in step 2, but the policy setting may be performed independently of the authorization of the user in step 2.

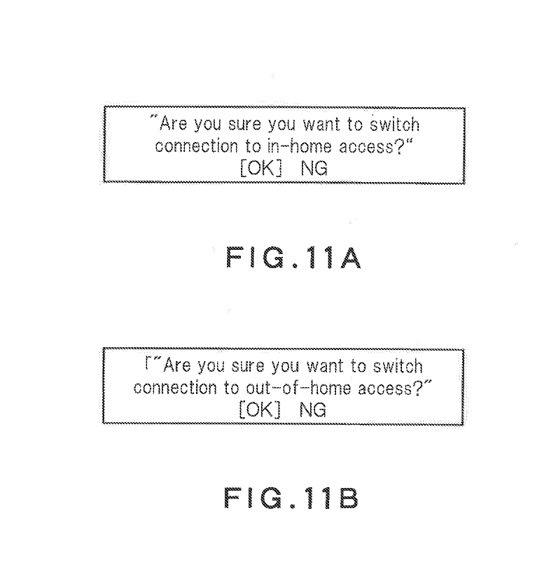

Between step 17 and step 18 in FIG. 5, the communication device 201 displays the confirmation screen for API switching (token switching), as step 17A. For example, the confirmation screen is displayed that causes the user to select whether to continuously use a public API or to switch to a private API. An example of the confirmation screen is shown in FIG. 11A. It is assumed here that the user select to switch to the private API.

Between step 21 and step 22 in FIG. 5, as step 21A, the access controller 141 of the access permission device 151 transmits an activating request for the private API to the target device 301. Upon receiving the activating request, the target device 301 makes the private API accessible from the home network. More specifically, the target device 301 starts the server function (an HTTP server) to be accessed by the client installed in the communication device 201. In contrast, the access controller 141 may be configured to make a deactivating request to the target device 301 when switching is made from the private API to the public API. In this case, the target device 301 stops the operation of the server function. Note that, when switching is made from the private API to the public API, a confirmation screen shown in FIG. 11B may be displayed, allowing the user to select whether to permit the switching.

Note that, in step 22, if the IP address of the target device 301 is changed, an access token for a new private API following this change can be issued.

As described above, according to the present embodiment, a user can perform control of switching between a public API and a private API based on more flexible policy setting. In addition, it is possible to avoid the case where a client fails to access the private API due to the change in the IP address of the target device 301. In addition, activating the private API only as needed enables an enhanced security of resource use in a home network.

### Third Embodiment

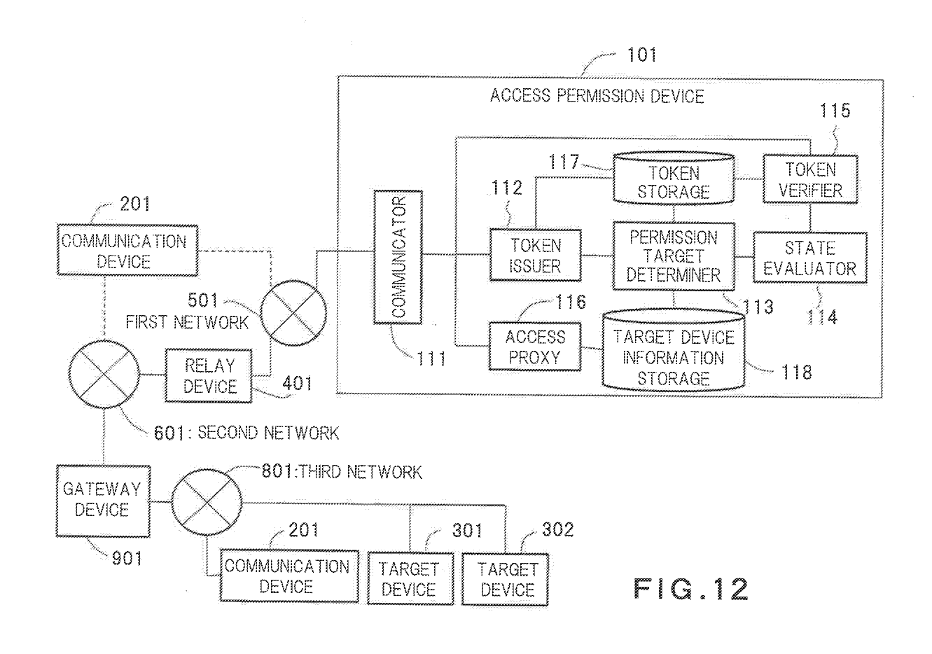

In the first and second embodiments, there is only one private API to access a target device in the in-home network, but there may be a plurality of private APIs. For example, a gateway device (see FIG. 9) may be provided with a plurality of private APIs. At this point, the access permission device (server) 101 does not know which private API should be permitted to be used by the communication device 201 so as to allow a client (an application) on the communication device 201 to operate (access) a target device. This will be described with reference to FIG. 12.

FIG. 12 shows an example of the communicating system according to the present embodiment. A gateway device 901 has a private API accessible from the interface on a second network 601 side (denoted by a private API-1), and a private API accessible from the Interface on the third network 801 side (denoted by a private API-2). The communication device 201 is connected to the second network 601 in the second embodiment but is connected to the third network 801 in FIG. 9. The case where the communication device 201 is connected to the second network 601 is shown by broken lines. In the gateway device 901, a network address on the second network 601 side and a network address on the third network 801 side are different from each other. For example, the network address on the second network 601 side is 192.192.168.0/24, and the network address on the third network 801 side is 192.168.126.0/24.

When the communication device 201 is connected to the third network 801, a client on the communication device 201 can operate a target device (301 or 302) via the gateway device 901 by accessing the private API-2. When accessing the private API-1, the client cannot operate the target device. On the other hand, when the communication device 201 is connected to the second network 601, the client on the communication device 201 can operate the target device via the gateway device 901 by accessing the private API-1. However, the client cannot operate the target device when accessing the private API-2.

If the access permission device 101 can grasp which of the second network 601 and the third network 801 the communication device 201 is connected to, the access permission device 101 can also notify appropriate private API information to the communication device 201 accordingly. However, in some cases, the access permission device 101 cannot grasp which network the communication device 201 is connected to. For example, due to a NAT function of the relay device 401, the transmission source IP addresses of transmitted packets from devices under the relay device 401 are translated into the global IP address of the relay device 401, and thus the access permission device 101 cannot determine which of the local networks (601 and 801) the communication device 201 is connected to.

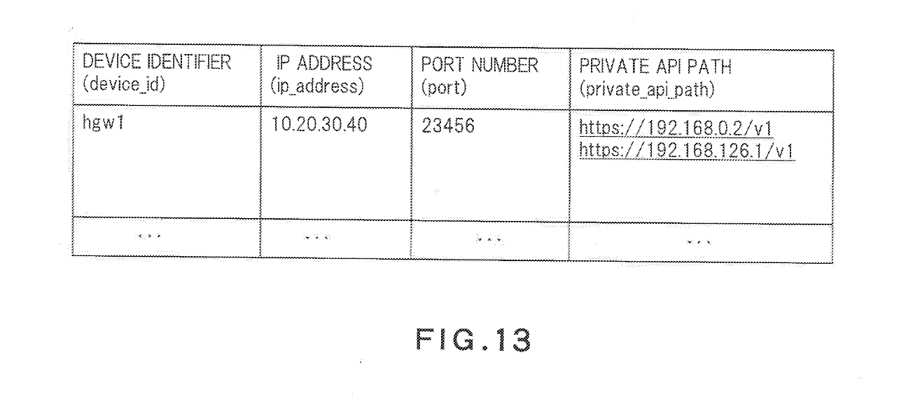

Thus, in the present embodiment, the access permission device 101 notifies a plurality of pieces of private API information on the gateway device to the communication device 201. The communication device 201 specifies an available piece of private API information from among the plurality of pieces of private API information and uses the specified pieces of private API information to access a target device (operates the target device) via the gateway device. FIG. 13 shows a configuration example of the target device information storage according to the present embodiment. Two private API paths of a gateway device having a device identifier of “hwg1” are registered. Note that the registration form for the API paths in FIG. 13 (and FIG. 3 described above) is a form in which an IP address is located between “https://” and “/V1”, but may be a form having only an IP address, a form without “/V1”, or the other forms.

An operation example of the present embodiment will be described below. Note that the same description as that made with reference to FIG. 9 will not be repeated.

First, there will be described, as initial setting, an operation example up to when the communication device 201 is issued with an access token.

A client (an application) running on the communication device 201 such as a smartphone transmits a token issuance request to the access permission device 101 to use a specific function (e.g., scheduling recording) in a target device (step 3 in FIG. 4).

The access permission device 101 having received the token issuance request performs client authentication and user authentication (step 5 and step 6). Along with the user authentication, a screen to ask a user for authentication may be displayed on the communication device 201. In this case, for example, the token issuance request may be transferred (redirected) to a authentication/permission URL. The user inputs his or her own authentication information and the user's intention of permission for using the specific function by the client. When any one of the authentication and the permission is not successfully performed, the access permission device 101 notifies the client that it has failed to perform token issuance.

When the authentication and the permission are successfully performed, an access token for public or private is issued to the client according to the state evaluation by the communication device (whether the communication device 201 is in home or out of home). Alternatively, in addition to the access token, a refresh token may be issued. A single access token assuming both the roles may be issued.

There will be described the subsequent API access procedure in the case where the communication device 201 (client) is out-of-home, and an access token for public access is issued.

The client having received the access token perform the public API access such as scheduling recording on the access permission device 101, based on the public API information (step 9 in FIG. 4). Prior to this, the client may request the state evaluation of the client (whether the client is in-home or out-of-home) from the access permission device or the like, to confirm that the client is out of home.

The access permission device having received the public API access performs the verification on the validity of the access token and performs the state evaluation on the communication device 201 (the client) (whether the communication device 201 is in home or out of home) (step 10 and step 11). When the access token is valid, and the communication device 201 is out of home, the access permission device performs control such as scheduling recording on the target device (e.g., recording device). Specifically, the access proxy 116 receives the access to a public API from the communication device 201 and transmits a resource use request to the target device 301 (step 12 and step 13). A manner in which the access proxy 116 uses resources of the gateway device 901 is previously defined. Dedicated APIs may be prepared, or data containing the URL of a private API may be transmitted to the gateway device 901, and the gateway device 901 may interpret and execute the URL of a private API contained in the data. On the other hand, when the access token is determined to be invalid, or the communication device 201 is determined to be in home, the access permission device notifies the client, as a response, that the public API access cannot be permitted (see step 16 and step 17, and a piece of the sequence “PERMISSION ERROR RESPONSE” following step 17 in FIG. 5).

Note that, in the investigation of the validity of the access token, when the access token is determined to be invalid, the access permission device may notify access information on the device itself (e.g., on making a token issuance request) to the client.

Assume that the user of the communication device 201 (the client) gets home from outside the home while holding the communication device 201. That is, assume that the communication device 201 changes its state from an out-of-home state to an in-home state. In this case, assume that the client on the communication device 201 performs public API access such as scheduling recording on the access permission device 101 based on the public API information (step 9 in FIG. 4). The access permission device 101 determines in the state evaluation of the communication device 201 that the communication device 201 is in home, and notifies the client, as a response, that the public API access cannot be permitted (see step 16 and step 17, and the piece of the sequence “PERMISSION ERROR RESPONSE” following step 17 in FIG. 5). This makes the client aware that the communication device 201 has gotten home from outside the home. Alternatively, as described above, the client may request the state evaluation from the access permission device or the like to confirm whether the communication device 201 is in the out-of-home state or the in-home state.

The client on the communication device 201 transmits a token issuance request (e.g., a request containing a refresh token) to the access permission device 101 (step 18 in FIG. 5), and the access permission device 101 verifies the refresh token and performs the state evaluation. Here, the verification succeeds, and the communication device 201 is determined to be in home. Then, the access permission device 101 determines permission target information (API information) to be provided to the communication device 201. Here, as described above, there are a plurality of private APIs for the device identifier of the gateway device 901 (device_id). In the example shown in FIG. 9 in the first embodiment, there is one private API path, but in the present embodiment, there are the plurality of private API paths. Note that each API path has a piece of API information (see FIG. 2) for each function (“status” or “reserved_program”).

The access permission device 101 transmits a list that contains a plurality of pieces of API information corresponding to the function (e.g., recording) requested by the client. Instead of the list of the pieces of API information, a list containing a plurality of API paths may be transmitted. It should be understood in this case that it is possible to generate API paths equivalent to the pieces of API information by appending a character string corresponding to the function to the end of the API paths on a terminal side. An API path is equivalent to a part of API information (e.g., API information from which a part specifying the function is removed) (see FIG. 2 and FIG. 3). The access permission device in some cases does not grasp that the communication device 201 is connected to which network identical to one among the plurality of interfaces included in the gateway device 901, when a piece of API information cannot be specified from among the plurality of pieces of API information. For this reason, the access permission device 101 provides a list of all the private API paths included in the gateway device (or all the pieces of private API information relevant to the function requested by the client). Note that the list of the private API paths may be provided to the client from the access permission device 101 when the client requests the state evaluation as described above.

The client having received the list of the plurality of pieces of private API information (or the list of the private API paths) has to determine which private API information is to be used. There are a plurality of conceivable methods therefor.

(First method) Each of the API paths is selected in turn, and for the selected API path, a message to request a response containing a device_id is transmitted. When the selected API path is an unavailable API path, no response is returned. When the selected API path is different from an expected API path, the responded device_id is different from the device_id (an expected value) of the device that the device itself intends to access (e.g., there may be the situation where a plurality of subnets exist, and there is a gateway device having the same IP address in each subnet). When the responded device_id matches the expected value, the selected API path is the correct value. After the API path having the correct value is found, API access is performed based on private API information containing the API path having the correct value (step 23 in FIG. 5). At this point, the gateway device 901 requests the access permission device 101 the verification of the token transmitted through the API access from the client (step 24 in FIG. 5). At this point, a token introspection endpoint included in the access permission device may be used.

(Second method) The client receives a server certificate (asymmetric), a pre-shared key (PSK, symmetric), or both of them from the access permission device 101 together with the list of the pieces of API information. The access permission device stores therein previously also the server certificate, pre-shared key, and the like, associating them with the device_id of the gateway device. The client determines an API path having the correct value using a validating function such as Transport Layer Security (TLS) and Datagram Transport Layer Security (DTLS). If an attempt at the authentication is made using an API path unavailable in the network, no response is returned from the gateway device 901 (a communication in the IP layer fails). In addition, if an API path different from the expected API path is used, the authentication fails. That is, although the communication in the IP layer succeeds, the authentication using TLS or the like falls. The operation after the correct API path is specified is the same as that of the first method.

The API path to be used may be determined using a method other than the first method and the second method.

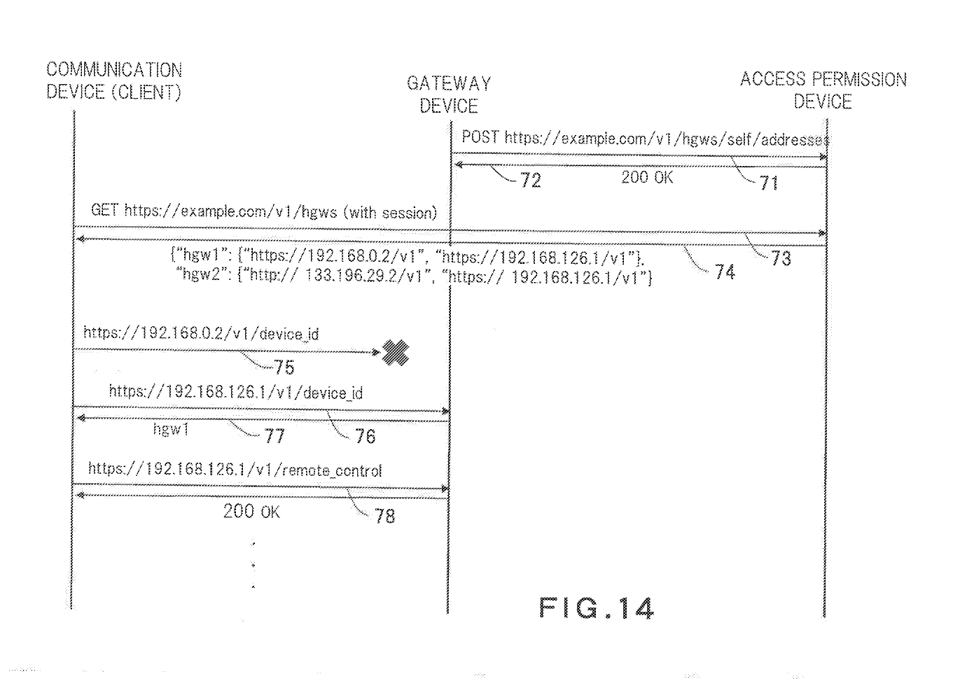

FIG. 14 shows a sequence example of operation in the case of acquiring a plurality of API paths from the access permission device to specify an API path to be used. The gateway device notifies a plurality of API paths included in the device itself to the access permission device (step 71). The access permission device registers the plurality of notified API paths and transmits a response (step 72). Note that the transmission destination address of a response packet is, for example, a global IP address (e.g., “133.196.29.2”), which is translated into a local IP address by the NAT function of the router 401, and the packet reaches the gateway device. Note that there are some configurations in which not only an IP address but also a destination port number is translated.

In the in-home state, assume that the client on the communication device requests the access permission device to transmit the list containing the plurality of API paths included in the gateway device, as a response (step 73).

The access permission device identifies a gateway device that is registered being associated with the user of the client (or identifies a gateway device that is registered being associated with the transmission source IP address of the packet of the request) and specifies the plurality of API paths included in the identified gateway device.

Here, the access permission device identifies two gateway devices (hgw1 and hgw2 in the drawing), and for each of them, specifies two API paths (an API path of a WAN side interface and an API path of a LAN side interface). Note that the API paths here are private API paths.

The access permission device transmits a message that contains one gateway device identifier “hgw1” and its two API paths, and the other gateway device identifier “hgw2” and its two API paths, to the client on the communication device, as a response (step 74).

The transmission destination address of the packet of the response is, for example, a global IP address (e.g., “133.196.29.2”), which is translated into a local IP address by the NAT function of the router 401, and the packet reaches the communication device (the client). Note that there are some configurations in which not only an IP address but also a destination port number is translated.

The client on the communication device first identifies the one gateway device (hgw1 here), selects one of among the plurality of API paths included in the identified gateway device, and transmits a message to request the transmission of a device_id as a response (step 75). However, the selected API path is unavailable in the network on the WAN side of the relevant gateway device, and thus no response to the message is transmitted (a timeout occurs). The communication device selects the other API path and transmits a message to request the transmission of a device_id as a response (step 76). The access permission device returns a response containing the identifier “hgw1” of the device itself to the relevant message (step 77). The identifier contained in this response matches the identifier expected by the client, and thus the client on the communication device makes private API access to the gateway device using the piece of API information based on the API path, so as to control the target device under the gateway device (step 78).

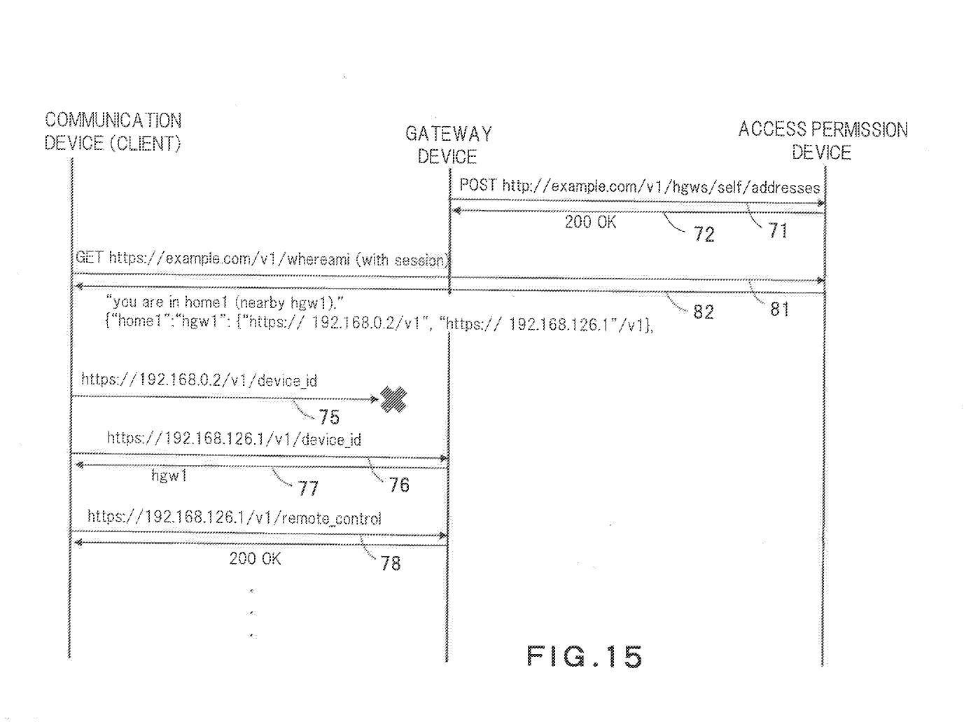

FIG. 15 shows the other sequence example of the operation in the case of acquiring a plurality of API paths from the access permission device to specify one API path to be used. The beginning steps 71 and 72 are the same as those in FIG. 14.

In step 81 following step 72, the client on the communication device transmits a message to make an inquiry about the state evaluation of the device itself (about whether it is in home or out of home). The access permission device determines through the state evaluation that the communication device is in home. In addition, the access permission device specifies here the gateway device hgw1 as a gateway device that can exist in home (only one gateway device is assumed to have been incidentally registered in the access permission device for the user or the transmission source IP address). The access permission device transmits a message containing the gateway device identifier “hgw1” and its two API paths to the client on the communication device as a response (step 82). The subsequent steps 75 to 78 are the same as those in FIG. 14.

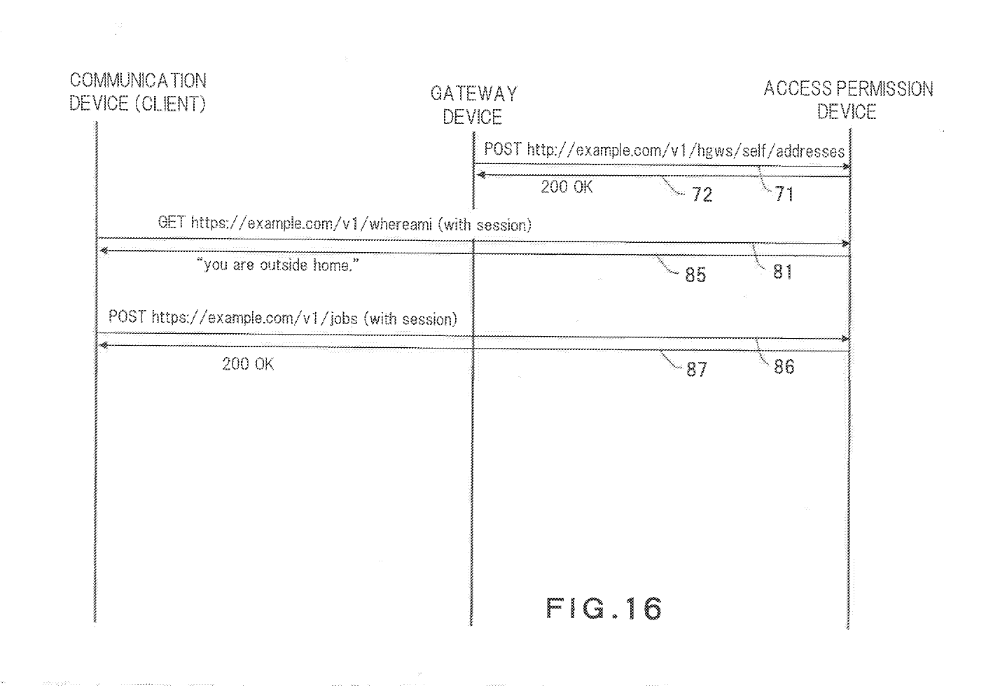

FIG. 16 shows an example of the operation in the case where it is determined in the sequence in FIG. 15 that the communication device is out of home. Steps 71, 72, and 81 are the same as those in FIG. 15.

As step 85 next to step 81, the access permission device transmits a message to provide a notification that the communication device is out of home. The client on the communication device makes public API access to the access permission device based on the public API information (steps 86 and 87). Note that the client on the communication device first makes a token issuance request if not issued with an access token for public access yet.

In the sequence in FIG. 14 described above, if the communication device performs the examination on each API path (step 75 and step 76) in the out-of-home state, the client does not find that the communication device is out of home until a timeout occurs for both API paths. At the time when the timeouts occur, the client can switch to the out-of-home access. In contrast, in the sequences in FIG. 15 and FIG. 16, the client requests the state evaluation from the access permission device, and thus client can operate after grasping previously whether it is in home and out of home. Therefore, the sequences in FIG. 15 and FIG. 16 have an advantage of preventing a delay in the operation in the out-of-home state.

### Fourth Embodiment

Assume the case where the first network 501 has a function of Carrier Grade NAT (CGN) or Large Scale NAT (LSN) (hereafter, denoted by CGN/LSN). In this case, a situation may arise in which the client cannot access any of the private API paths notified from the access permission device although the communication device is determined to be in home through the state evaluation performed by the access permission device.

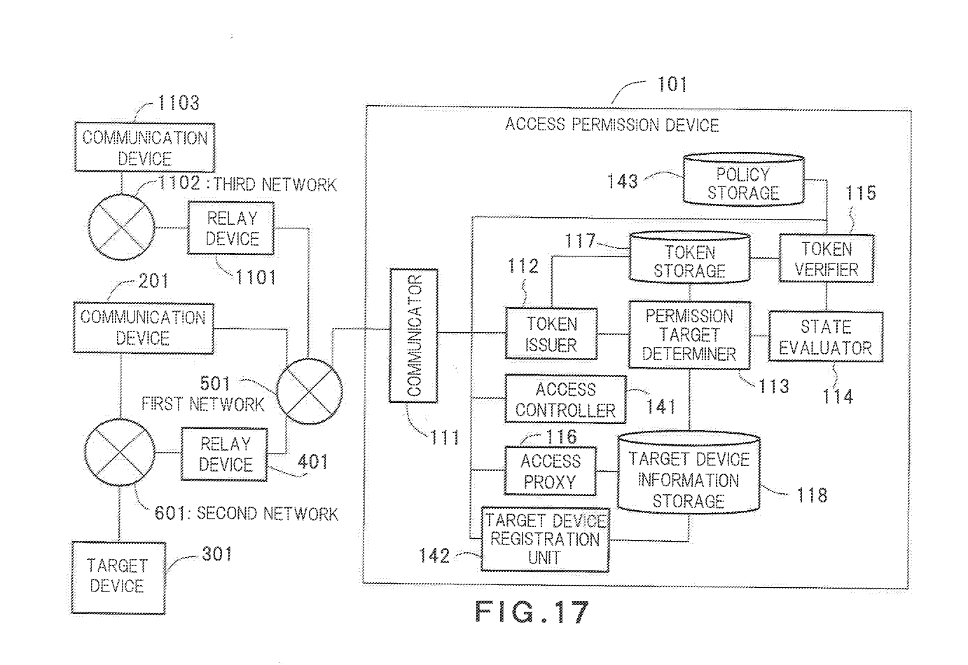

FIG. 17 shows a configuration example the communicating system according to the present embodiment. The communicating system in FIG. 17 is based on the configuration in FIG. 10. The first network 501 has the function of CGN/LSN. A relay device 1101 and a third network 1102 are disposed in a building other than that of the relay device 401, the second network, and the target device 301. A communication device 1103 is a communication device such as a smartphone. The third network 1102 is, for example, a home network (a local network). Note that the third network 1102 may be the other kind of network as with the second network 601. The relay device 1101 is a broadband router having a NAT function. In FIG. 17, the communication device 1103 is connected to the third network 1102. The communication device 1103 is connected to the first network 501 via the relaying device 101. Alternatively, the communication device 1103 can be directly connected to the first network 501.

Consider the case of controlling the target device 301 connected to the second network 601 when the communication device 1103 is connected to the third network 1102. A client on the communication device 1103 transmits a token issuance request for private API access to the access permission device 151 via the relay device 1101 (step 18 in FIG. 5). The access permission device performs the token verification and the state evaluation, and determines that the communication device 1103 is in home.

In the case where the first network 501 has the function of CGN/LSN, both the WAN interfaces of the relay device 1101 and the relay device 401 (interfaces on a first network 501 side) may be assigned with local IP addresses. In this case, a packet transmitted from the home of the relay device 401 and a packet transmitted from the building of the relay device 1101 are transmitted to the access permission device 151, with the transmission source IP addresses of both the packets translated into the same global IP address by CGN/LSN. Therefore, when performing the state evaluation based on the IP addresses, the access permission device 151 cannot distinguish whether the communication device 1103 is connected to the third network 1102 or the second network 601. For this reason, the access permission device determines that the communication device 1103 is in the home of the relay device 401, and transmits to the communication device 1103 a response containing the private API path of (or the private API information on) the target device 301. Note that it is assumed here that there is no API-accessible target device in the third network 1102.

The client on the communication device 1103 tries to accessing the target device 301 using the notified private API information but fails to access the target device 301 because it does not exist in the same building (the local network) as that of the target device 301. For example, An error may arises in which an error message indicating a failure of transferring the packet is returned from a router in the first network 501, a timeout occurs, or the IP address of the target device 301 cannot be acquired with DNS in a case that the private API path is expressed with use of a domain name or the like. To solve this problem, there are a plurality of conceivable methods as follows. In the present embodiment, one of these methods is implemented.

(First method) After a lapse of a certain amount of time from the error occurrence, the client on the communication device 1103 requests the state evaluation from the access permission device or makes a token issuance request to the access permission device (step 18 in FIG. 5). In the network having the CGN/LSN function, network parts to which an NAT is applied may change with time. In this case, there may be a possibility that a packet from the relaying device 1101 (which has only a local IP address) is converted to a packet an source address of which is a global IP address #1, and a packet from the relaying device 401 is converted to a packet an source address of which is a global IP address #2 (at certain time point, the global IP addresses from the relaying device 1101 and 401 were both the global IP address #1.). This makes the target device information storage 118 of the access permission device, or the like, to be updated, which can cause change of the result of the state evaluation. For example, the communication device 1103 is determined to be out of home of the relaying device 401. This causes the access permission device to determine that the communication device 1103 is out of home, and a public API path (or public API information) is transmitted to the communication device 1103. The communication device 1103 operates the target device 301 via the access permission device 151 based on the public API information.

(Second method) The communication device 1103 transmits to the access permission device 151 a message to which a flag is set, the flag indicating that the target device 301 cannot be accessed using the private API information notified by the access permission device 151. When receiving the message with the set flag, the access permission device skips the state evaluation. At this point, the skip of the state evaluation may be logged. In the case where the state evaluation is skipped, the access permission device 151 may notify public API information for the target device 301 or Issue an access token for public access, to the communication device 1103.

(Third method) The communication device 1103 transmits a message that contains an error detail at the time of a failure of access using private API information (e.g., a response packet) to the access permission device 151. The access permission device records the error detail contained in the message in a storage device such as a memory device. It is evaluated whether the error detail is likely, through comparison with error details reported in the past or the other information (a well-known likelihood determination may be made). When the likelihood is a given value or more, the state evaluation may be skipped, and the same process as described above may be performed.

The access permission device, a communication device and a target device in each embodiment as described above may also be realized using a general-purpose computer device as basic hardware. That is, each function block in each device (the access permission device, the communication device and the target device) can be realized by causing a processor mounted in the above general-purpose computer device to execute a program. In this case, the each device may be realized by installing the above described program in the computer device beforehand or may be realized by storing the program in a storage medium such as a CD-ROM or distributing the above described program over a network and installing this program in the computer device as appropriate. Furthermore, the storage and the database in each device may also be realized using a memory device or hard disk incorporated in or externally added to the above described computer device or a storage medium such as CD-R, CD-RW, DVD-RAM, DVD-R as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An access permission device comprising:
a communicator to communicate with a target device that is connected to a network and with a communication device that is capable of using a resource provided by the target device;
a state evaluator to acquire information to determine a connection state between the communication device and the network from at least one of the communication device and the target device, and to judge the connection state based on the information;
an access proxy to transmit a use request for the resource provided by the target device, to the target device; and
a determiner to determine, based on the connection state, which of the communication device and the access proxy transmits a use request for the resource provided by the target device, to the target device.

2. The access permission device according to claim 1, wherein
the state evaluator evaluates whether the communication device is connected to the network or in a connectable state to the network.

3. The access permission device according to claim 2, wherein
when the communication device is connected to the network or in the connectable state to the network, the determiner determines that the communication device transmits the use request to the target device and transmits, to the communication device, instruction information on the transmission of the use request to the target device.

4. The access permission device according to claim 3, wherein
after transmitting the instruction information to the communication device, when the determiner receives from the communication device a report indicating that an error occurs in the transmission of the use request to the target device, the determiner determines that the access proxy transmits the use request to the target device, and
the access proxy transmits the use request to the target device according to the determination by the determiner.

5. The access permission device according to claim 2, wherein
when the communication device is not connected to the network or in a unconnectable state to the network, the determiner determines that the access proxy transmits the use request to the target device, and
the access proxy transmits the use request to the target device in accordance with the determination by the determiner.

6. The access permission device according to claim 1, wherein
the communicator receives a first request transmitted from the communication device, and
the state evaluator evaluates the connection state when the first request is received.

7. The access permission device according to claim 6, wherein
the first request is at least one of a permission request relating to the resource or a use request for the resource.

8. The access permission device according to claim 7, wherein
in a case where, in accordance with the evaluation of the connection state based on the permission request, the communication device is evaluated not to be connected to the network or to be in an unconnectable state to the network, a first permission response is transmitted to the communication device, the first permission response containing information relevant to a first application programming interface (API) with which the access proxy accepts a use request for the resource, and
when the access proxy receives from the communication device a use request for the resource based on the information relevant to the first API, the access proxy transmits the use request for the resource to the target device.

9. The access permission device according to claim 7, wherein
in a case where, in accordance with the evaluation of the connection state based on the use request for the resource from the communication device, the communication device is evaluated to be connected to the network or to be in a connectable state to the network, an error response is transmitted to the communication device, and
after the transmission of the error response, the permission request relating to use of the resource from the communication device is received, and in a case where, in accordance with the evaluation of the connection state based on the permission request, the communication device is evaluated to be connected to the network or in a connectable state to the network, a second authentication response that contains instruction information on transmitting the use request is transmitted to the communication device.

10. The access permission device according to claim 9, wherein
the second permission response contains information relevant to a second application programming interface (API) with which the target device accepts a use request for the resource.

11. The access permission device according to claim 10, wherein
the second API is an API with which a gateway device accepts a use request for the resource to the target device, and
the communicator communicates with the gateway device instead of the target device.

12. The access permission device according to claim 11, wherein
the second permission response contains information relevant to a plurality of the second APIs, and
the gateway device is connected to a plurality of networks, and the second API accessible differs among the networks.

13. The access permission device according to claim 7, wherein
in a case where, in accordance with the evaluation of the connection state based on a use request for the resource from the communication device, the communication device is evaluated to be connected to the network or to be in the connectable state to the network, a response is transmitted to the communication device, the response containing information relevant to a plurality of second APIs,
the second API is an API with which a gateway device accepts a use request for the resource to the target device,
the communicator communicates with the gateway device instead of the target device, and
the gateway device is connected to a plurality of networks, and the second API accessible differs among the networks.

14. The access permission device according to claim 6, wherein
the state evaluator evaluates whether the communication device is connected to the network, according to a fact that a transmission source IP address of the first request received from the communication device matches an IP address that is registered for the target device previously or falls within an IP address range that is registered previously.

15. The access permission device according to claim 6, wherein
the state evaluator receives, from the communication device, information to identify a location where the communication device is present, and evaluates whether the communication device is in a connectable state to the network based on the received information and position information on the target device that is previously acquired.

16. The access permission device according to claim 1, wherein
when the state evaluator evaluates that the communication device is connected to the network or in a connectable state to the network, instruction information on activating a function of accepting a use request for the resource is transmitted to the target device.

17. The access permission device according to claim 1, wherein
when the state evaluator evaluates that the communication device is not connected to the network or in an unconnectable state to the network, instruction information on deactivating a function of accepting a use request for the resource is transmitted to the target device.

18. The access permission device according to claim 1, wherein
when evaluation is changed from evaluation that the communication device is not connected to the network or in an unconnectable state to the network to evaluate that the communication device is connected to the network or in a connectable state to the network, whether to obtain approval for the change from a user of the communication device is determined based on policy information previously provided, and in a case of needing to obtain the approval, instruction information on transmitting the resource use request to the target device is transmitted to the communication device after information indicating the approval from the user is received.

19. The access permission device according to claim 1, wherein
also in a case where the policy information provided previously indicates that the access proxy acts as proxy in transmission of a use request for a resource even when the communication device is connected to the network or in a connectable state to the network, the access proxy transmits the resource use request to the target device even then the communication device is connected to the network or in the connectable state to the network.

20. The access permission device according to claim 1, wherein
when it is evaluated that the communication device is connected to the network or in a connectable state to the network, the communicator disconnects communication connection with the target device.

21. An access permission method comprising:
acquiring information to determine a connection state between a communication device and a network from at least one of the communication device and a target device, and to evaluate the connection state based on the information, the target device being connected to a network and the communication device being capable of using a resource provided by the target device; and
determining, based on the connection state, which of the communication device and the access proxy transmits, to the target device, a use request for the resource provided by the target device.

22. A non-transitory computer readable medium having a program stored therein, which when executed by a computer, causes the computer to perform processing comprising:
acquiring information to determine a connection state between a communication device and a network from at least one of the communication device and a target device, and to evaluate the connection state based on the information, the target device being connected to a network and the communication device being capable of using a resource provided by the target device; and
determining, based on the connection state, which of the communication device and the access proxy transmits, to the target device, a use request for the resource provided by the target device.

23. A computing system comprising:
the access permission device of claim 1, and
at least one of the target device and the communication device.

24. The communicating system according to claim 23, comprising both of the target device and the communication device.
